(19) United States
(12) Patent Application Publication
(10) Pub. No.: US 2012/0242622 A1
(43) Pub. Date: Sep. 27, 2012

(54) TOUCH MODULE

(76) Inventors: Yu Tseng, Hsin-Chu (TW); Po-Fu Huang, Hsin-Chu (TW); Chang-Hsiao Lee, Hsin-Chu (TW)

(21) Appl. No.: 13/253,932

(22) Filed: Oct. 5, 2011

(30) Foreign Application Priority Data
Mar. 21, 2011 (TW) 100109528

(51) Int. Cl. G06F 3/042

(52) U.S. Cl. 345/175

(57) ABSTRACT

A touch module includes a panel device, an outer frame, and an optical sensor. The panel device includes an array substrate and a display panel having a touch surface. The array substrate is electrically connected to the display panel. The outer frame is disposed on the panel device. The optical sensor is disposed between the panel device and the outer frame, including a wire, at least one lens, a photosensitive chip, and a reflection mirror. The wire is formed on the array substrate. The lens is disposed between the display panel and the outer frame for guiding light transmitted from the touch surface. The photosensitive chip is electrically connected to one end of the wire. The reflection mirror is disposed above the photosensitive chip for reflecting the light guided by the lens to the photosensitive chip.

### BACKGROUND

1. Technical Field

The disclosure relates to a touch module, and more specifically, to a touch module having an optical sensor, in which a lens and a photosensitive chip are disposed on a display panel and an array substrate respectively and a reflection mirror is disposed above the photosensitive chip.

2. Related Art

In general, an optical touch module utilizes a light interruption method to detect a position of a user's finger or a stylus on a touch surface. The light interruption method involves utilizing an optical sensor (respectively disposed at the left and right corners of the touch surface) to detect light of a light emitting unit emitted from the touch surface, so as to establish a mechanism for optical touch positioning on the touch surface. In such a manner, when a user's finger (or a stylus) touches the touch surface to interrupt the light partially, the optical sensor can determine the corresponding touch position of the user's finger according to the intensity variation of the light.

As known above, the optical sensor is the key component of the optical touch module, and its conventional configuration is to dispose the optical sensor on a glasses cover or a sheet component (e.g. a color filter or a polarizer) in a panel device. For example, please refer to FIG. 1, FIG. 2, FIG. 3, and FIG. 4. FIG. 1 is a diagram of an optical sensor 10 according to the prior art. FIG. 2 is a sectional diagram of the optical sensor 10 in FIG. 1 along a sectional line A-A′. FIG. 3 is a diagram of an outer frame 12 and a panel device 14 according to the prior art. FIG. 4 is a sectional diagram of the outer frame 12 in FIG. 3 along a sectional line B-B′. The panel device 14 is briefly depicted by assembly of a display panel 16 and an array substrate 18. As shown in FIG. 1 and FIG. 2, the optical sensor 10 includes a casing 20, a lens 22, an infrared filter 24, a photosensitive chip 26, a printed circuit board 28, and a signal cable 30. The lens 22 and the infrared filter 24 are disposed above the photosensitive chip 26 and fixed into the casing 20, for transmitting light emitted from a touch surface of the panel device 14 to the photosensitive chip 26. The printed circuit board 28 is electrically connected to the photosensitive chip 26 for controlling the photosensitive chip 26. The signal cable 30 (e.g. a flexible printed circuit cable) is electrically connected to the printed circuit board 28 for transmitting optical signals to the array substrate 18. As shown in FIG. 3 and FIG. 4, the optical sensor 10 is disposed at the left and right corners of the touch surface of the panel device 14 respectively. The configuration of the optical sensor 10, the outer frame 12, and the panel device 14 is as shown in FIG. 4.

However, since positioning between the optical sensor 10 and the panel device 14 is performed by utilizing human eyes or an assembly machine to make the optical sensor 10 align with a positioning hole of the casing 20, positioning tolerances may easily occur between the optical sensor 10 and the panel device 14. Thus, positioning accuracy of the lens 22 in the optical sensor 10 relative to the touch surface of the panel device 14 may be influenced by the said positioning tolerances and assembly tolerances among the casing 20, the lens 22, the infrared filter 24, the photosensitive chip 26 and the printed circuit board 28, so as to cause incorrect optical touch positioning.

Furthermore, as mentioned above, the optical sensor 10 needs to utilize the casing 20 for fixing its interior components (i.e. the lens 22, the infrared filter 24, the photosensitive chip 26, and the printed circuit board 28). As a result, the overall thickness of the optical sensor 10 is accordingly increased due to disposal of the casing 20, and it is disadvantageous for the thinning design of the optical touch module. Furthermore, since the optical sensor 10 needs to additionally utilize the signal cable 30 to transmit optical signals to the array substrate 18, it causes a complicated wiring design and a time-consuming and strenuous assembly process.

### SUMMARY

The disclosure relates to a touch module including a panel device, an outer frame, and an optical sensor. The panel device includes a display panel and an array substrate. The display panel has a touch surface. The array substrate is electrically connected to the display panel. The outer frame is disposed on the panel device. The optical sensor is disposed between the panel device and the outer frame. The optical sensor includes a wire, at least one lens, a photosensitive chip, and a reflection mirror. The wire is formed on the array substrate. The lens is disposed between the display panel and the outer frame for guiding light transmitted from the touch surface. The photosensitive chip is electrically connected to one end of the wire. The reflection mirror is disposed above the photosensitive chip for reflecting the light guided by the lens to the photosensitive chip.

These and other objectives of the disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an optical sensor according to the prior art.

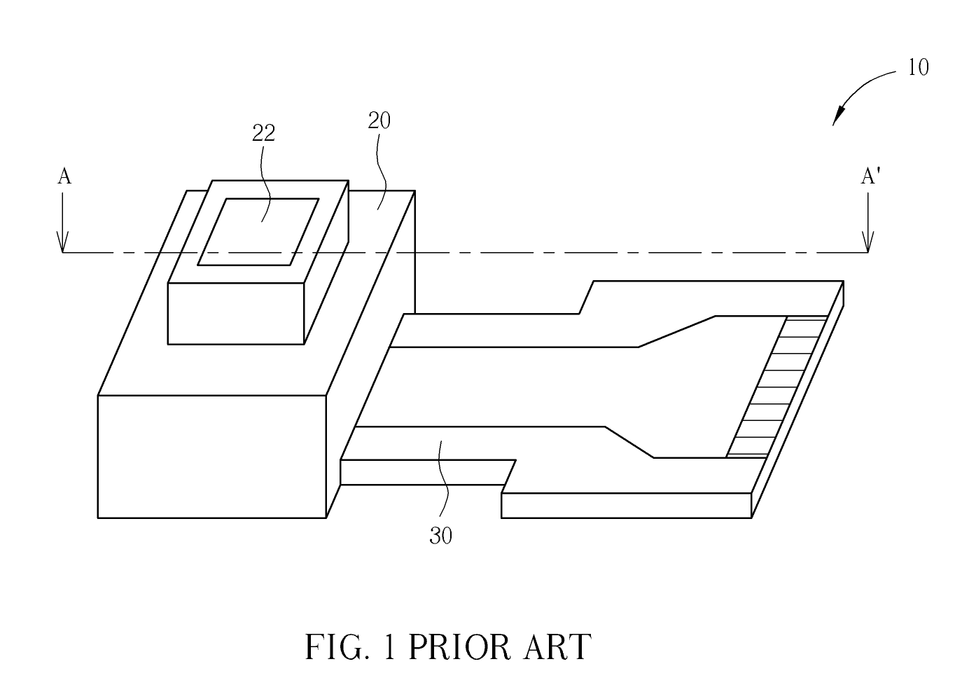

FIG. 2 is a sectional diagram of the optical sensor in FIG. 1 along a sectional line A-A′.

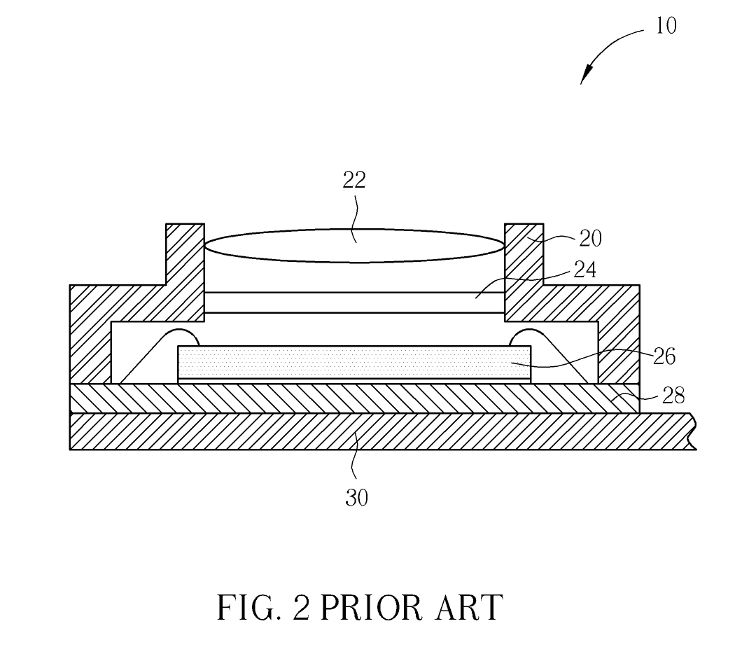

FIG. 3 is a diagram of an outer frame and a panel device according to the prior art.

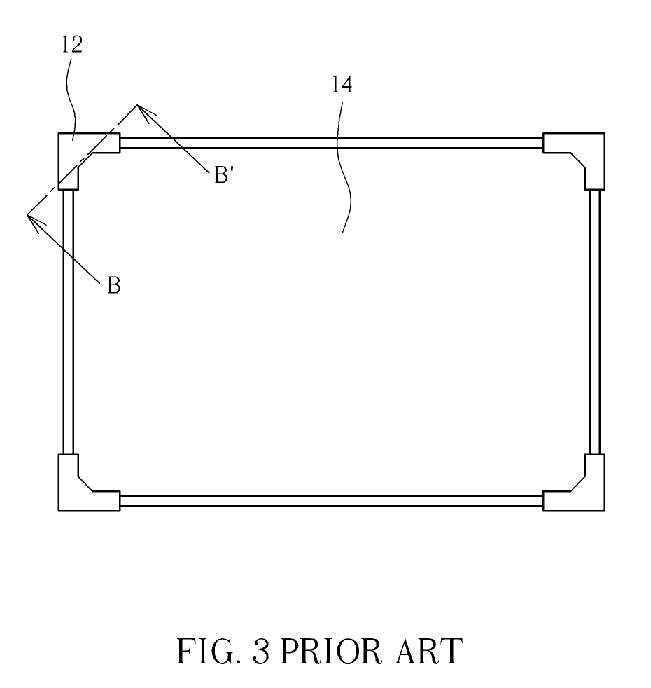

FIG. 4 is a sectional diagram of the outer frame in FIG. 3 along a sectional line B-B′.

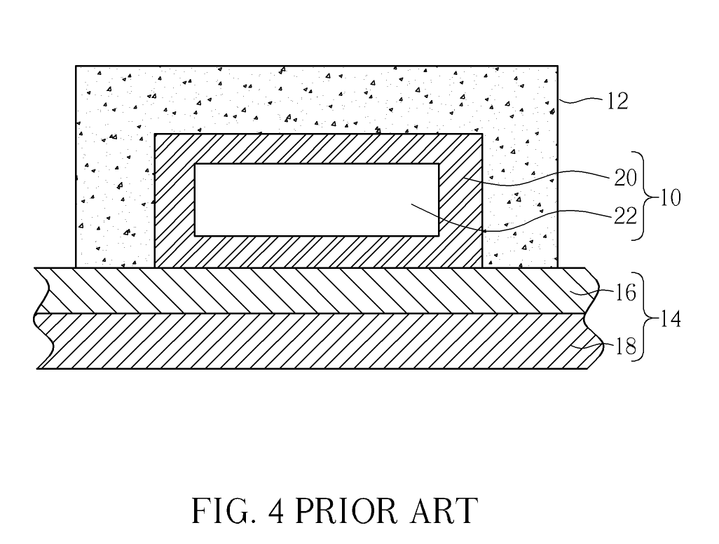

FIG. 5 is a diagram of a touch module according to an embodiment of the disclosure.

FIG. 6 is a sectional diagram of the touch module in FIG. 5 along a sectional line C-C′.

FIG. 7 is an enlarged sectional diagram of the touch module in FIG. 5 along a sectional line D-D′.

FIG. 8 is a sectional diagram of a reflection mirror being extendedly connected to a lens according to another embodiment of the disclosure.

FIG. 9 is a sectional diagram of the reflection mirror being extendedly connected to a photosensitive chip according to another embodiment of the disclosure.

### DETAILED DESCRIPTION

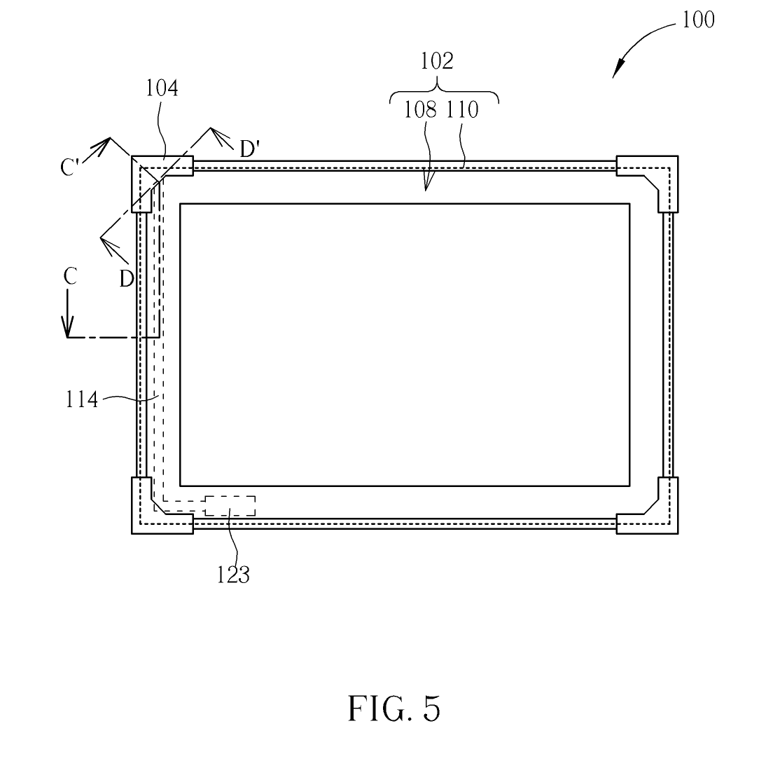

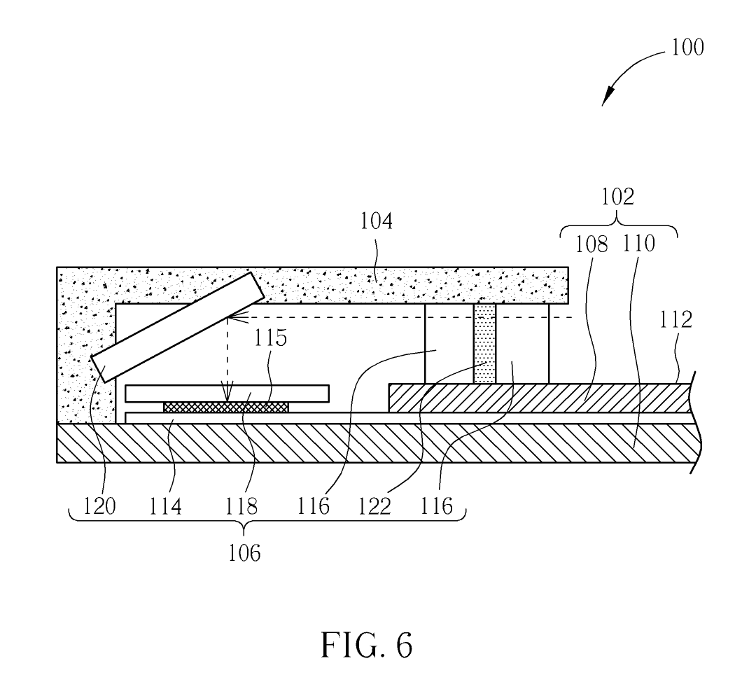

Please refer to FIG. 5 and FIG. 6. FIG. 5 is a diagram of a touch module 100 according to an embodiment of the disclosure. FIG. 6 is a sectional diagram of the touch module 100 in FIG. 5 along a sectional line C-C′. As shown in FIG. 5 and FIG. 6, the touch module 100 includes a panel device 102, an outer frame 104, and an optical sensor 106. In this embodiment, the panel device 102 is briefly depicted by assembly of a display panel 108 and an array substrate 110, and related description for other components in the panel device 102 is omitted herein since they are commonly seen in the prior art. The display panel 108 has a touch surface 112 for a user to perform touch operations. The array substrate 110 is electrically connected to the display panel 108 for controlling display of the display panel 108. The outer frame 104 is disposed on the panel device 102 for fixing the panel device 102.

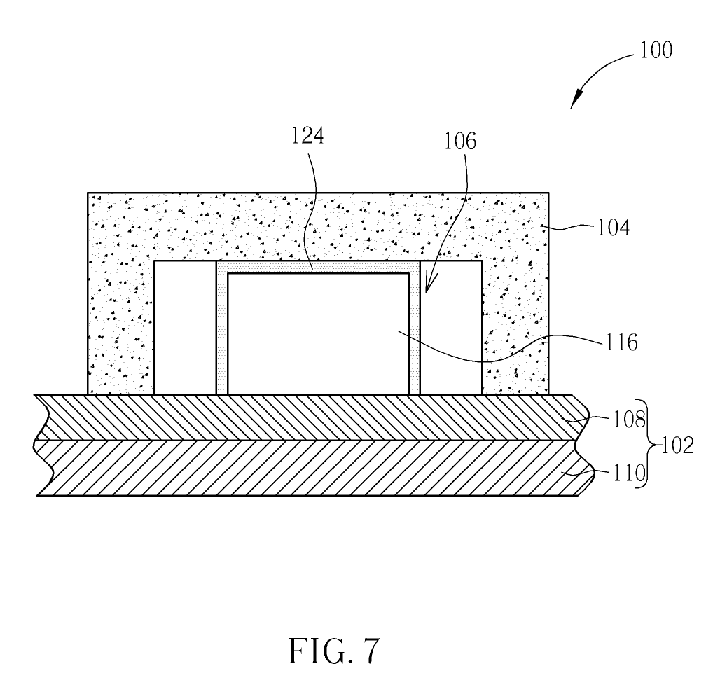

More detailed description for the configuration of the optical sensor 106 is provided as follows. Please refer to FIG. 5, FIG. 6, and FIG. 7. FIG. 7 is an enlarged sectional diagram of the touch module 100 in FIG. 5 along a sectional line D-D′. As shown in FIG. 5, FIG. 6, and FIG. 7, the optical sensor 106 includes a wire 114, at least one lens 116 (two shown in FIG. 6, but not limited thereto), a photosensitive chip 118, a reflection mirror 120, an infrared filter 122, and a driving chip 123. The wire 114 is formed on the array substrate 110. The wire 114 is used to transmit optical signals to the driving chip 123 for the following positioning process of the touch module 100. The wire 114 is made of Indium-Tin-Oxide material. That is, the wire 114 can be electrically connected to the array substrate 110 by directly forming on the array substrate 110 via a conventional semiconductor manufacturing process, such as a GOA (Gate on Array) process, instead of additionally utilizing flexible printed circuit (FPC) cables and flexible flat cables (FFC). Similarly, the driving chip 123 can be electrically connected to an end of the wire 114 and formed on the array substrate 110 by the said process, so as to efficiently saving related wiring and assembly costs. The lens 116 is disposed between the display panel 108 and the outer frame 104. In this embodiment, the lens 116 can be preferably disposed on a sheet component of the display panel 108, such as a color filter or a polarizer, and disposal of the lens 116 can be performed by a conventional connecting design utilized in a panel manufacturing process for precisely fixing a position of the lens 116 relative to the display panel 108. The infrared filter 122 is disposed between the two lenses 116 as shown in FIG. 6, meaning that the optical sensor 106 utilizes assembly of the lenses 116 and the infrared filter 122 to transmit light emitted from the touch surface 112 to the reflection mirror 120. To be noted, as shown in FIG. 7, at least one side surface (three shown in FIG. 7) of the lens 116 has a light shielding layer 124 attached thereto for preventing stray light from being incident into the lens 116 through a gap between the lens 116 and the outer frame 104. As for the method for forming the light shielding layer 124 on the side surface of the lens 116 (e.g. utilizing a coating process or light shielding tapes), its related description is omitted herein since it is commonly seen in the prior art.

In this embodiment, the photosensitive chip 118 is preferably a CMOS (Complementary Metal-Oxide Semiconductor) photosensitive chip. The touch module 100 further includes an anisotropic conductive film (ACF) 115. The anisotropic conductive film 115 is located between the photosensitive chip 118 and the wire 114. Thus, the photosensitive chip 118 is electrically connected to another end of the wire 114 by the anisotropic conductive film 115, but is not limited thereto. In other words, the photosensitive chip 118 can utilize other suitable conductive film to electrically connect to the wire 114 instead. The reflection mirror 120 is disposed on a position of the outer frame 104 corresponding to the photosensitive chip 118. In this embodiment, the reflection mirror 120 is fixed to the outer frame 104 by an integrally-forming process (e.g. an insert molding process), but is not limited thereto. For example, the reflection mirror 120 can also utilize other fixing design, such as a structure engaging design. In such a manner, the reflection mirror 120 can be precisely positioned above the photosensitive chip 118 so that light transmitted from the lenses 116 and the infrared filter 122 can be precisely reflected to the photosensitive chip 118. Subsequently, corresponding optical signals can be transmitted to the driving chip 123 via the wire 114 as shown in FIG. 5 for the following positioning process of the touch module 100.

In the following, the light sensing design of the optical sensor 106 is described in detail. After the touch module 100 utilizes light emitted by a light emitting unit (not shown in figures) to be distributed over the touch surface 112, the touch module 100 utilize assembly of the lenses 116 and the infrared filter 122 to receive the light (depicted by a dotted arrow in FIG. 6) emitted from the touch surface 112. Subsequently, as shown in FIG. 6, the lenses 116 and the infrared filter 122 guide the received light to the reflection mirror 120. Finally, the light is reflected to the photosensitive chip 118 by the reflection mirror 120 for detecting the intensity variation of the light, so as to establish a mechanism for optical touch positioning on the touch surface 112. In such a manner, when a user's finger (or a stylus) touches the touch surface 112 to interrupt the light partially, the optical sensor 106 can determine the corresponding touch position of the user's finger according to the intensity variation of the light.

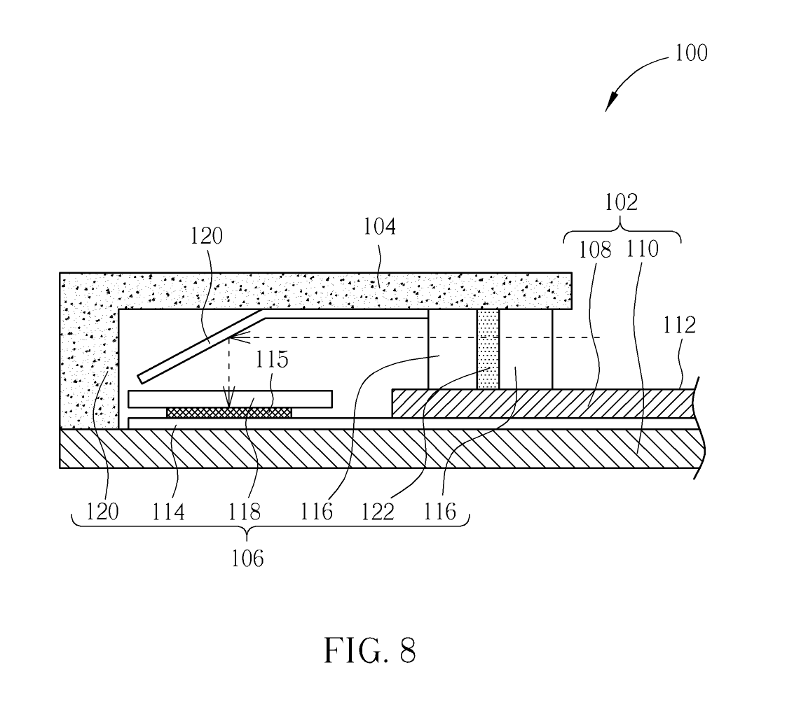

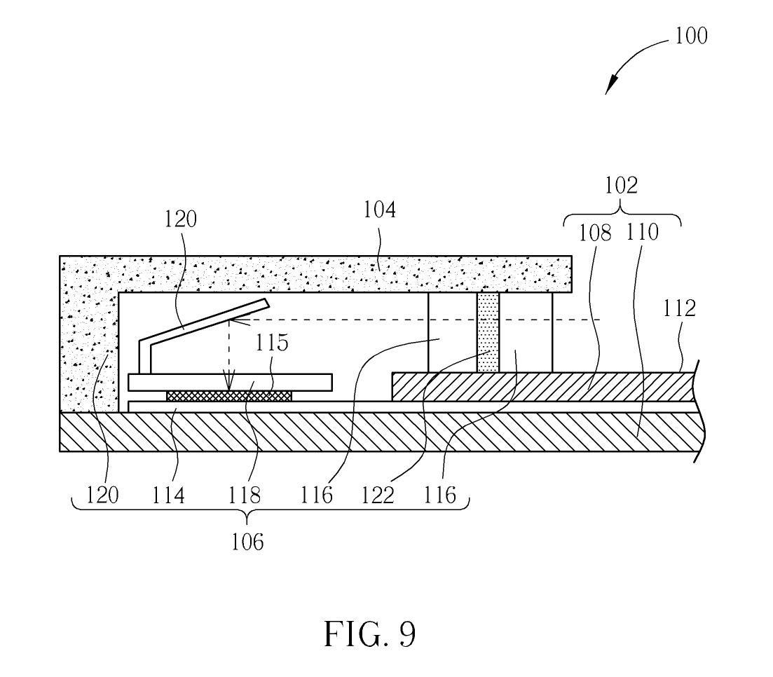

It should be mentioned that the positioning design for the reflection mirror 120, the outer frame 104, the photosensitive chip 118, the lens 116 and the infrared filter 122 is not limited to the said embodiment, meaning that the optical sensor 106 can also utilize other positioning design. For example, the optical sensor 106 can utilize an end of the reflection mirror 120 to extendedly connect to the lens 116. The related design can be as shown in FIG. 8, which is a sectional diagram of the reflection mirror 120 being extendedly connected to the lens 116 according to another embodiment of the disclosure. Accordingly, the reflection mirror 120 can be precisely positioned above the photosensitive chip 118 while fixing the lens 116 onto the display panel 108. The related connecting design utilized in the said example is commonly seen in the prior art, such as utilizing an injection molding process to make the reflection mirror 120 integrally formed with the lens 116. In another example, the optical sensor 106 can utilize an end of the reflection mirror 120 to extendedly connect to the photosensitive chip 118, meaning that the reflection mirror 120 is extendedly formed from the photosensitive chip 118 and then located above the photosensitive chip 118. The related design can be as shown in FIG. 9, which is a sectional diagram of the reflection mirror 120 being extendedly connected to the photosensitive chip 118 according to another embodiment of the disclosure. Accordingly, the reflection mirror 120 can be precisely positioned above the photosensitive chip 118 while attaching the photosensitive chip 118 onto the array substrate 110. As for which design is utilized, it depends on the practical application of the optical sensor 106. Furthermore, the infrared filter 122 and the light shielding layer 124 are omissible components for simplifying the manufacturing process and structural design of the optical sensor 106.

In summary, in the disclosure, the lens is directly disposed on the display panel, the wire of the photosensitive chip is directly formed on the array substrate, the photosensitive chip is directly electrically connected to the wire by the conductive film, and the reflection mirror is disposed above the photosensitive chip to reflect light transmitted from the lens to the photosensitive chip. In such a manner, since there is no need to utilize a casing to fix the said components in the disclosure, the occupied space of the optical sensor in the touch module is reduced greatly, and it is advantageous for the thinning design of the touch module. Furthermore, since the disclosure utilizes the design that the wire is directly formed on the array substrate (e.g. by a GOA process) instead of additionally utilizing flexible printed circuit cables and flexible flat cables to transmit optical signals to the driving chip, as well as utilizes the design that the driving chip is directly formed on the array substrate, the disclosure accordingly avoids a complicated wiring design and a time-consuming and strenuous assembly process. Thus, the packaging cost of the touch module can be decreased greatly.

Furthermore, as mentioned above, in the disclosure, not only the lens and the photosensitive chip can be positioned on the display panel and the array substrate respectively by a conventional connecting design utilized in a semiconductor manufacturing process instead of a manual positioning method by human eyes and an automatic positioning method by an assembly machine, but the reflection mirror can also be precisely positioned by integrally forming with the outer frame (or the lens) or extendedly connecting to the photosensitive chip. Thus, positioning and assembly tolerances among the photosensitive chip, the reflection chip, and the lens can be greatly decreased, so as to enhance positioning accuracy of the lens relative to the touch surface. Accordingly, optical touch positioning of the touch module can be performed more precisely.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch module comprising:
a panel device comprising:
a display panel having a touch surface; and
an array substrate electrically connected to the display panel;
an outer frame disposed on the panel device; and
an optical sensor disposed between the panel device and the outer frame, the optical sensor comprising:
a wire formed on the array substrate;
at least one lens disposed between the display panel and the outer frame for guiding light transmitted from the touch surface;
a photosensitive chip electrically connected to one end of the wire; and
a reflection mirror disposed above the photosensitive chip for reflecting the light guided by the lens to the photosensitive chip.

2. The touch module of claim 1, wherein the lens is disposed on a color filter or a polarizer of the display panel.

3. The touch module of claim 1 further comprising:
an anisotropic conductive film located between the photosensitive chip and the wire.

4. The touch module of claim 1, wherein the wire comprises Indium-Tin-Oxide.

5. The touch module of claim 1, wherein the reflection mirror is disposed at a position of the outer frame corresponding to the photosensitive chip.

6. The touch module of claim 5, wherein the reflection mirror and the outer frame are integrally formed.

7. The touch module of claim 1, wherein an end of the reflection mirror is extendedly connected to the lens.

8. The touch module of claim 7, wherein the reflection mirror is integrally formed with the lens by an injection molding process.

9. The touch module of claim 1, wherein an end of the reflection mirror is extendedly connected to the photosensitive chip.

10. The touch module of claim 1, wherein at least one side surface of the lens has a light shielding layer attached thereto.

11. The touch module of claim 1, wherein the optical sensor further comprises:
an infrared filter disposed at a side of the lens.

12. The touch module of claim 1, wherein the photosensitive chip is a CMOS (Complementary Metal-Oxide Semiconductor) photosensitive chip.

13. The touch module of claim 1, wherein the optical sensor further comprises:
a driving chip electrically connected to another end of the wire and formed on the array substrate for controlling the photosensitive chip.
